(19) United States
(12) Patent Application Publication
(10) Pub. No.: US 2014/0021341 A1
(43) Pub. Date: Jan. 23, 2014

(54) OPTICAL ENCODER, MOTOR APPARATUS, AND METHOD FOR PROCESSING SIGNAL OF OPTICAL ENCODER

(71) Applicant: KABUSHIKI KAISHA YASKAWA DENKI, Kitakyushu-shi (JP)

(72) Inventor: Noriyuki NAGAE, Kitakyushu-shi (JP)

(21) Appl. No.: 13/935,420

(22) Filed: Jul. 3, 2013

(30) Foreign Application Priority Data
Jul. 19, 2012 (JP) 2012-160513

(51) Int. Cl. G01D 5/347

(52) U.S. Cl. CPC G01D 5/347
USPC 250/231.1

(57) ABSTRACT

An optical encoder includes a to-be-detected medium including slits to reflect and transmit light. An optical source radiates light to the to-be-detected medium. A photodetector detects the light reflected by the slits or transmitted through the slits, and generates an electrical signal corresponding to an amount of the detected light. The correction value storage stores an offset correction value used to eliminate or reduce an offset component contained in the electrical signal. The adjustor adjusts an amount of the radiated light or the offset correction value so that a ratio between the offset correction value and the amount of the radiated light is approximately constant. The signal corrector corrects the electrical signal corresponding to the amount of the adjusted light, or corrects the electrical signal using the adjusted offset correction value. The position detector detects a position of the to-be-detected medium.

### CROSS-REFERENCE TO RELATED APPLICATIONS

The present application claims priority under 35 U.S.C. §119 to Japanese Patent Application No. 2012-160513, filed Jul. 19, 2012. The contents of this application are incorporated herein by reference in their entirety.

### BACKGROUND OF THE INVENTION

1. Field of the Invention

The present invention relates to an optical encoder, a motor apparatus, and a method for processing a signal of the optical encoder.

2. Discussion of the Background

Optical encoders are known to optically detect a position of a to-be-detected medium. For example, an optical encoder recited in Japanese Patent No. 4058659 includes an optical source (light emitting device) and a photodetector. Light is emitted from the optical source and detected by the photodetector. The photodetector generates an electrical signal that corresponds to the amount of the light that has been received. Then, this optical encoder performs light emission amount control, by which the amount of the light emitted from the optical source is controlled based on a feedback result of the electrical signal from the photodetector.

### SUMMARY OF THE INVENTION

According to one aspect of the present invention, an optical encoder includes a to-be-detected medium, an optical source, a photodetector, a correction value storage, an adjustor, a signal corrector, and a position detector. The to-be-detected medium includes slits arranged at predetermined intervals to reflect and transmit light. The optical source is configured to radiate light to the to-be-detected medium. The photodetector is configured to detect the light radiated from the optical source and reflected by the slits or transmitted through the slits, and is configured to generate an electrical signal corresponding to an amount of the light that has been detected. The correction value storage stores an offset correction value used to eliminate or reduce an offset component contained in the electrical signal. The adjustor is configured to adjust at least one of an amount of the light radiated from the optical source and the offset correction value in accordance with at least one of the electrical signal and a moving velocity of the to-be-detected medium so that a ratio between the offset correction value and the amount of the light radiated from the optical source is approximately constant. The signal corrector is configured to correct, using the offset correction value, the electrical signal corresponding to the amount of the light that has been radiated from the optical source and that has been adjusted by the adjustor, or is configured to correct the electrical signal using the offset correction value that has been adjusted by the adjustor, so as to eliminate or reduce the offset component. The position detector is configured to detect a position of the to-be-detected medium using the electrical signal that has been corrected by the signal corrector.

According to another aspect of the present invention, a motor apparatus includes a motor and an optical encoder. The motor is configured to rotate a shaft. The optical encoder is configured to detect a position of the shaft. The optical encoder includes a to-be-detected medium, an optical source, a photodetector, a correction value storage, an adjustor, a signal corrector, a position detector. The to-be-detected medium is coupled to the shaft and includes slits arranged at predetermined intervals to reflect or transmit light. The optical source is configured to radiate light to the to-be-detected medium. The photodetector is configured to detect the light radiated from the optical source and reflected by the slits or transmitted through the slits, and is configured to generate an electrical signal corresponding to an amount of the light that has been detected. The correction value storage stores an offset correction value used to eliminate or reduce an offset component contained in the electrical signal. The adjustor is configured to adjust at least one of an amount of the light radiated from the optical source and the offset correction value in accordance with at least one of the electrical signal and a moving velocity of the to-be-detected medium so that a ratio between the offset correction value and the amount of the light radiated from the optical source is approximately constant. The signal corrector is configured to correct, using the offset correction value, the electrical signal corresponding to the amount of the light that has been radiated from the optical source and that has been adjusted by the adjustor, or is configured to correct the electrical signal using the offset correction value that has been adjusted by the adjustor, so as to eliminate or reduce the offset component. The position detector is configured to detect a position of the to-be-detected medium using the electrical signal that has been corrected by the signal corrector.

According to the other aspect of the present invention, a method for processing a signal of an optical encoder is executed by an optical encoder. The optical encoder includes a to-be-detected medium, an optical source, a photodetector, and a correction value storage. The to-be-detected medium includes slits arranged at predetermined intervals to reflect or transmit light. The optical source is configured to radiate light to the to-be-detected medium. The photodetector is configured to detect the light radiated from the optical source and reflected by the slits or transmitted through the slits, and is configured to generate an electrical signal corresponding to an amount of the light that has been detected. The correction value storage stores an offset correction value used to eliminate or reduce an offset component contained in the electrical signal. The method includes adjusting, by an adjustor, the amount of the light that has been radiated from the optical source or the offset correction value in accordance with at least one of a moving velocity of the to-be-detected medium and the electrical signal so that a ratio between an amount of the light radiated from the optical source and the offset correction value is approximately constant. By a signal corrector using the offset correction value, the electrical signal corresponding to the amount of the emitted light that has been adjusted by the adjustor is corrected, or by the signal corrector, the electrical signal is corrected using the offset correction value that has been adjusted by the adjustor, so as to eliminate or reduce the offset component. By a position detector, a position of the to-be-detected medium is detected using the electrical signal that has been corrected by the signal corrector.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 illustrates a relationship between the amount of light emission and the amount of an offset component;

FIG. 2 is a diagram illustrating a servo system according to a first embodiment;

FIG. 3 is a diagram illustrating a reflective encoder according to the first embodiment;

FIG. 4 is a diagram illustrating a disk according to the first embodiment;

FIG. 5 is a diagram illustrating an optical module according to the first embodiment;

FIG. 6 is a diagram illustrating a position data generator according to the first embodiment;

FIG. 7 is a graph used to illustrate filtering characteristic information;

FIG. 8 illustrates the amount of electrification, the amount of light emission, and the amount of change in an offset component with the optical source having been degraded;

FIG. 9 is a graph used to illustrate adjustment amount information;

FIG. 10 illustrates exemplary operations of the position data generator according to the first embodiment based on a signal processing method of a reflective encoder;

FIG. 11 is a diagram illustrating a position data generator according to a second embodiment; and

FIG. 12 illustrates exemplary operations of the position data generator according to the second embodiment based on a signal processing method of a reflective encoder.

### DESCRIPTION OF THE EMBODIMENTS

The embodiments will now be described with reference to the accompanying drawings, wherein like reference numerals designate corresponding or identical elements throughout the various drawings.

Prior to description of the embodiments, the following describes circumstances that the inventors have conceived as a result of their extensive research and study.

When an optical encoder is used in the manner as in the embodiments described below, the light radiated from the optical source is reflected by or transmitted through the slits of the to-be-detected medium, and the reflected or transmitted light is received (detected) by the photodetector. From the photodetector, an electrical signal (also referred to as a reception light signal or a detection signal) is generated corresponding to the amount of the light that has been received. The generated electrical signal turns into, for example, a sinusoidal signal depending on whether there are slits. Then, such electrical signal is used to detect the position of the to-be-detected medium. Here, the slits are arranged at a pitch of 360° in electrical angle, and electrical signals having a phase shift of 90° are obtained. Ideally, the phase-shifted electrical signals draw a Lissajous figure having a constant radius with the point 0 as a center.

However, the electrical signals are influenced by leak light or other occurrences that cause them to encounter an offset, forming sine waves having centers at points that are offset from the point 0. This is because an electrical signal contains a component that varies its intensity in accordance with the position of the to-be-detected medium and that is used to detect the position of the to-be-detected medium (such component being what is called an alternating current component), and a component that has a constant intensity irrespective of the position of the to-be-detected medium (such component being what is called an offset component). A Lissajous figure drawn based on such electrical signals has its center offset from the point 0. Detecting the position of the to-be-detected medium using such Lissajous figure ends up in errors. In view of this, an offset correction value is stored in advance for use in eliminating (or reducing, which applies in the description that follows) the offset component contained in an electrical signal that results under the exemplary condition that a predetermined amount of light has been radiated from the optical source. Then, this offset correction value is used to eliminate the offset component from the electrical signal, thus correcting the electrical signal, and the corrected electrical signal is used to detect the position of the to-be-detected medium. This improves detection accuracy in detecting the position of the to-be-detected medium.

Incidentally, the inventors' study has found that the amount of the offset component contained in an electrical signal corresponds to the amount of light emission from the optical source (also referred to as the amount of light radiation); when the amount of light emission changes, the amount of the offset component contained in the electrical signal changes accordingly.

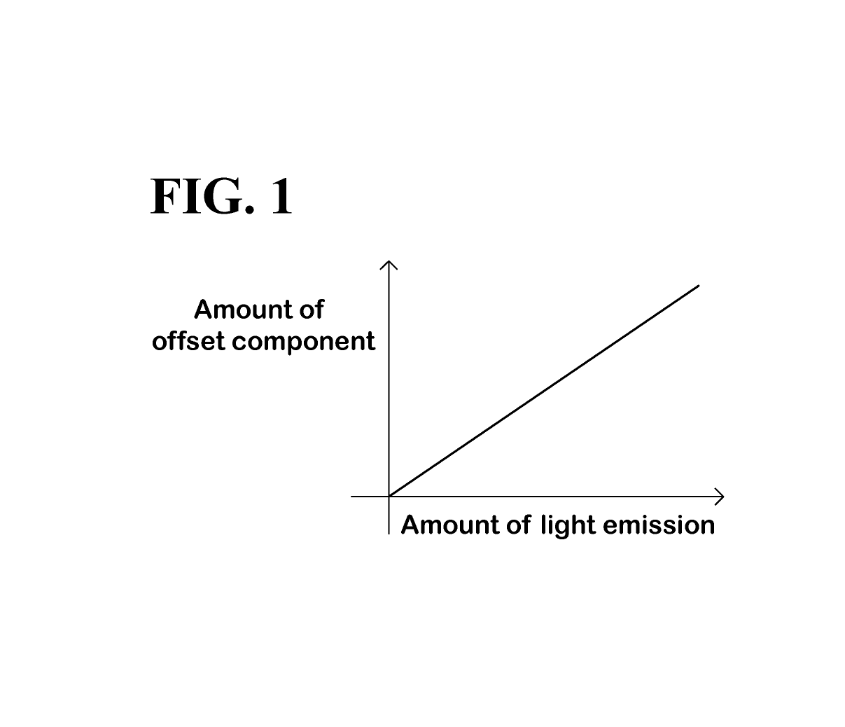

In the following description, by referring to FIG. 1, a relationship between the amount of light emission and the amount of the offset component will be described. FIG. 1 is a graph of the amount of the offset component against the amount of light emission with the amount of light emission on the horizontal axis and the amount of the offset component on the vertical axis. In the example shown in the graph, as the amount of light emission increases, the amount of the offset component increases proportionally. It should be noted, however, that this relationship between the amount of light emission and the amount of the offset component will not be limited to such proportional relationship.

Thus, since the amount of the offset component contained in the electrical signal changes in conjunction with a change in the amount of light emission as described above, if the electrical signal is corrected using, at any time, the above-described offset correction value stored in advance, then the offset component may not be eliminated sufficiently, and detection accuracy in detecting the position of the to-be-detected medium may degrade. Meanwhile, the light emission amount control of the background art is performed to accommodate to, for example, changes with time in the amount of light emission or other occurrences due to degradation over time, changes in temperature, and other causes. However, even if such light emission amount control is performed to control the amount of light emission at an approximately constant value, thereby attempting to inhibit an offset of the amount of light emission, the amount of light emission may still encounter an offset.

With these circumstances conceived, the inventors conducted further extensive research and study, and as a result, have conceived the optical encoders and other elements according to the embodiments described below. These embodiments will be described in detail below. It should be noted that the problems and advantageous effects described in the embodiments are presented for exemplary purposes only, and it will be readily appreciated that the embodiments provide additional operations and advantageous effects.

The optical encoders according to the embodiments described below will find applications in various types of optical encoders such as rotary (rotary type) optical encoders and linear (linear type) optical encoders. In the embodiments described below, a rotary optical encoder is taken as an example to facilitate understanding of the optical encoder according to each embodiment. Other types of applications of optical encoders are viable by making appropriate changes such as changing the to-be-detected medium from the rotary type (for example, a disk or like element) to the linear type (for example, a linear scale or like element), which will not be elaborated in the following description.

### 1. First Embodiment

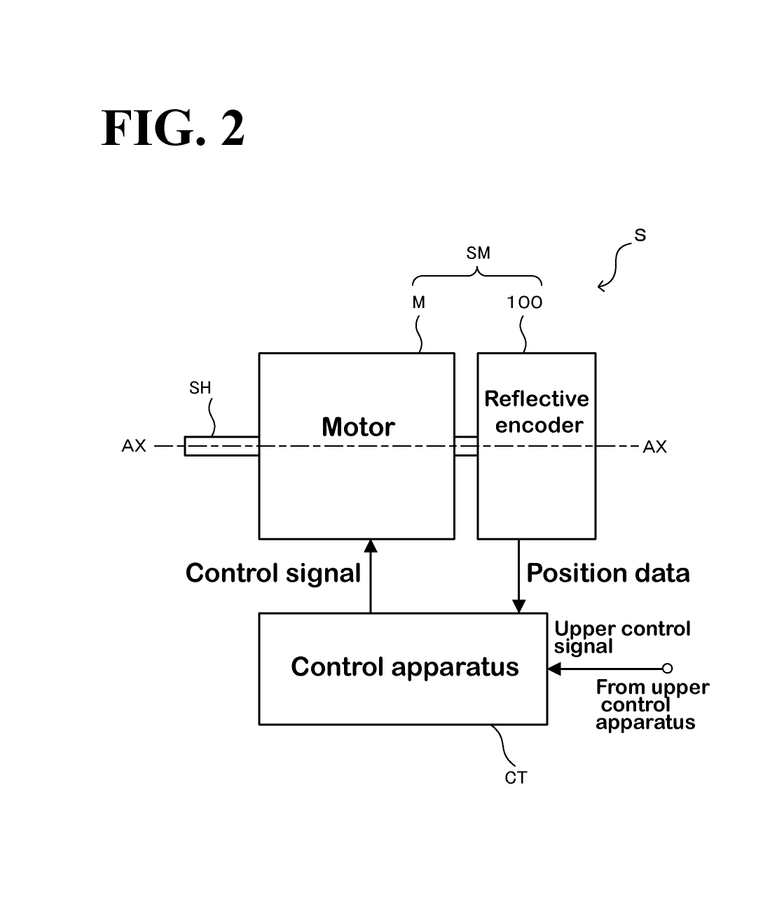

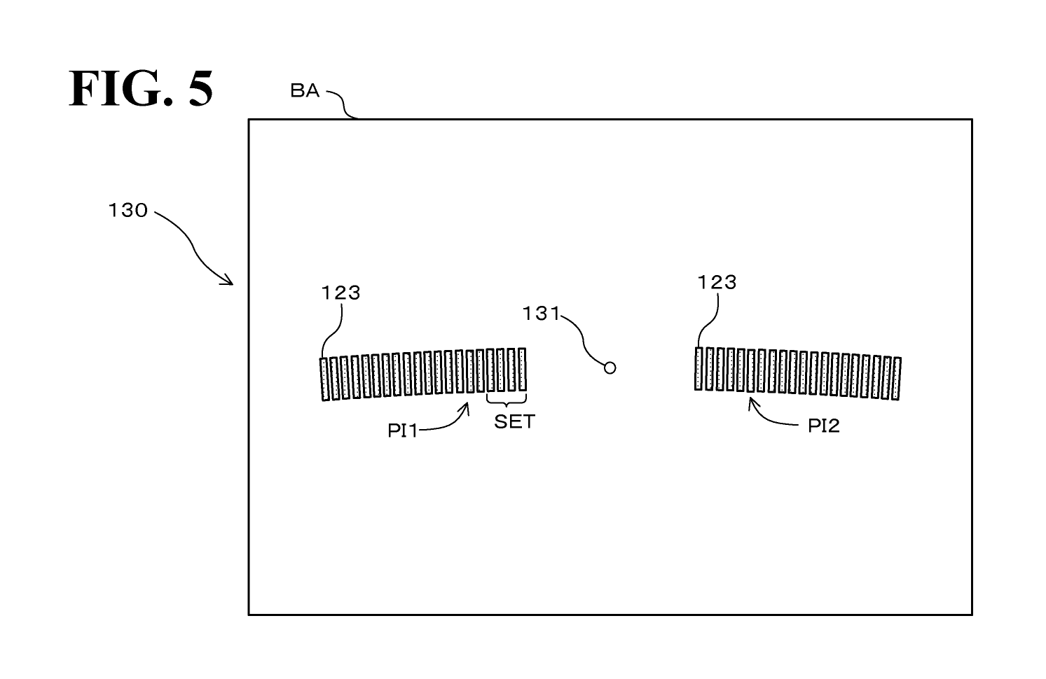

First, by referring to FIGS. 2 to 10, a first embodiment will be described.

### 1-1. Servo System

First, by referring to FIG. 2, a configuration of a servo system according to this embodiment will be described.

As shown in FIG. 2, a servo system S according to this embodiment includes a servo motor SM (an example of the motor apparatus) and a control device CT. The servo motor SM includes a reflective encoder 100 (an example of the optical encoder) and a motor M.

The motor M is an exemplary power source without the reflective encoder 100. Although this motor M alone is occasionally referred to as a servo motor, in this embodiment the configuration of the reflective encoder 100 includes the servo motor SM. The motor M includes a shaft SH. The shaft SH rotates about a rotation axis AX to output rotational force.

There is no particular limitation to the motor M insofar as it is a motor that is controlled based on data detected by the reflective encoder 100, examples including position data. Also the motor M will not be limited to an electric motor, which utilizes electricity as power source. Examples of motors that use other power sources include hydraulic motors, pneumatic motors, and steam motors. In the following description, the motor M is an electric motor for the sake of description.

The reflective encoder 100 is coupled to the shaft SH on the opposite side of the motor M's output side of rotational force. The reflective encoder 100 detects the position (angle) of the shaft SH, thereby detecting a position x (also referred to as a rotation angle 0) of the motor M, and outputs position data indicating the position x.

The position where the reflective encoder 100 is disposed will not be particularly limited to the examples illustrated in this embodiment. For example, the reflective encoder 100 may be directly coupled to the output side of the shaft SH, or may be coupled to the shaft SH and other elements through other mechanisms such as a reducer and a rotation direction changing mechanism.

The control device CT acquires the position data output from the reflective encoder 100, and controls rotation of the motor M based on the position data. In this embodiment, where an electric motor is used as the motor M, the rotation of the motor M is controlled by the control device CT controlling current or voltage to be applied to the motor M based on the position data. The control device CT may further acquire an upper control signal from an upper control apparatus (not shown), and control the motor M so that the rotational force output from the shaft SH of the motor M is enough to realize the position or other parameter indicated by the upper control signal. When the motor M uses some other type of power source, hydraulic, pneumatic, or steam, then the control device CT is capable of controlling supply from the power source, thereby controlling rotation of the motor M.

### 1-2. Reflective Encoder

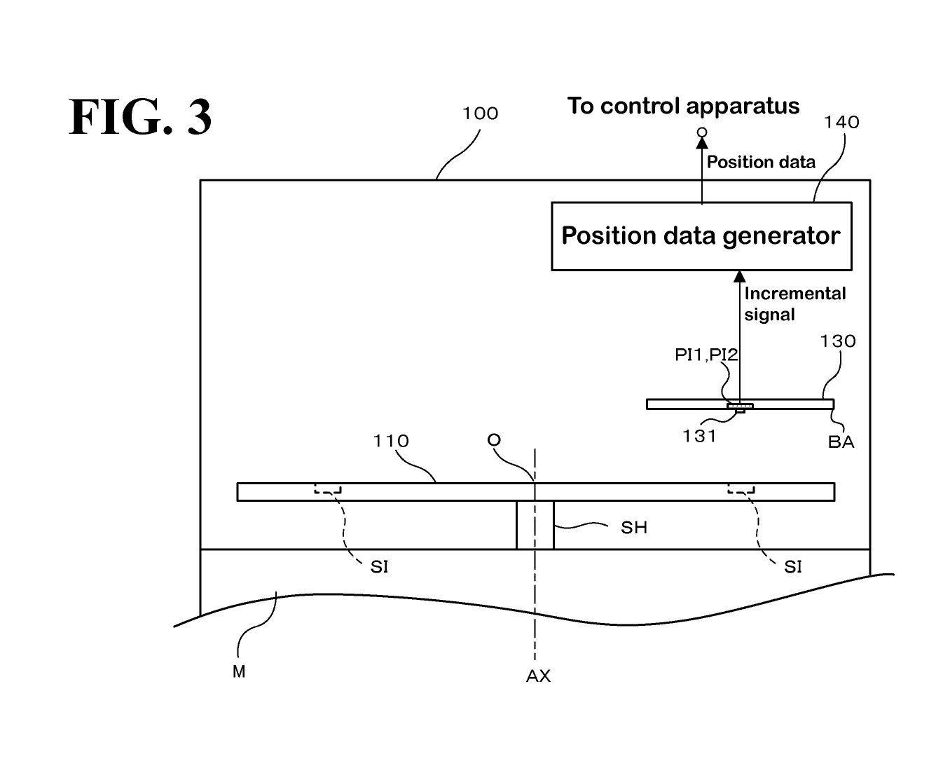

Next, by referring to FIGS. 3 to 6, the reflective encoder 100 according to this embodiment will be described.

As shown in FIG. 3, the reflective encoder 100 according to this embodiment includes a disk 110 (an example of the to-be-detected medium), an optical module 130, and a position data generator 140. The disk 110 has a circular-plate shape. The optical module 130 is disposed to face the disk 110. The optical module 130 is mounted on a substrate BA.

### 1-3. Disk

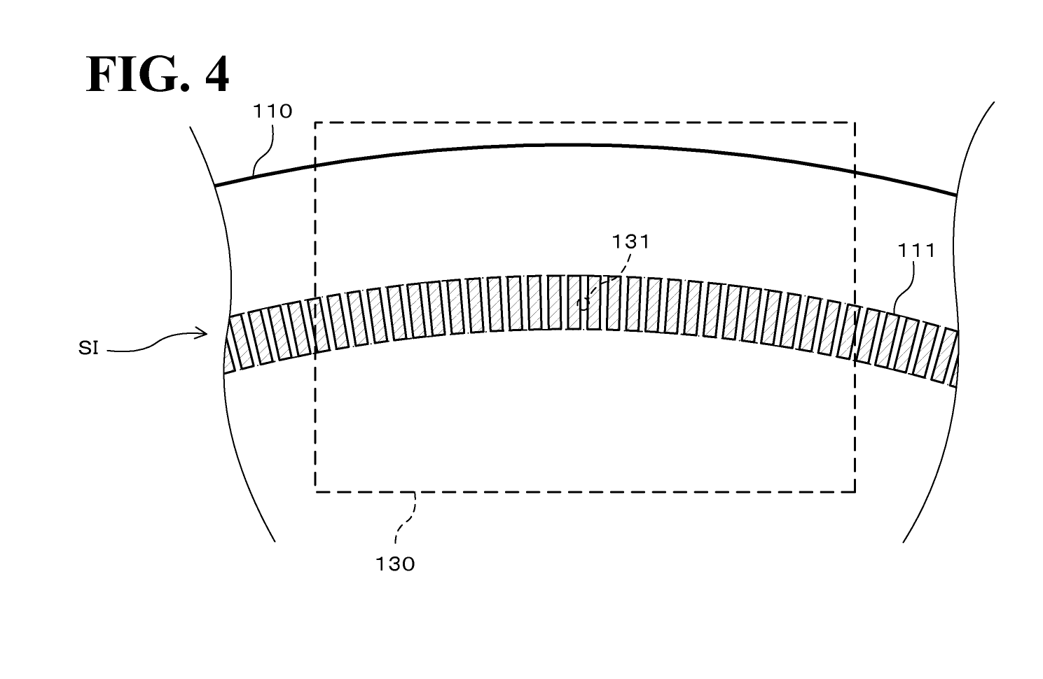

As shown in FIGS. 3 and 4, the disk 110 is disposed to have its disk center 0 approximately aligned with the rotation axis AX. The disk 110 is coupled to the shaft SH of the motor M, so that the disk 11 rotates by rotation of the motor M, that is, rotation of the shaft SH. The disk 110 may also be coupled to the shaft SH through, for example, a hub or like element. While in this embodiment the disk 110 is taken as an example of the to-be-detected medium to measure rotation of the motor M, it is also possible to use some other member as the to-be-detected medium, examples including an end surface of the shaft SH.

On the surface of the disk 110 facing the optical module 130, a ring-shaped slit array SI is formed having a plurality of reflection slits 111 (examples of the slits) arranged over the entire circumference of the disk 110 in its circumferential direction. The individual reflection slits 111 reflect light radiated from an optical source 131 (described later). The reflection slits 111 are disposed to have an incremental pattern. The incremental pattern is a pattern of regular repetition of slits at a predetermined pitch. The incremental pattern indicates the position of the motor M on a one-pitch basis or within one pitch in the form of a sum of electrical signals from one or more photodetectors 123 (described later).

The disk 110 in this embodiment is formed of glass, for example. The reflection slits 111 constituting the slit array SI can be formed by applying a light-reflecting member to the surface of the disk 110. The material of the disk 110 will not be limited to glass; it is also possible to use metal, resin, or other material. The reflection slits 111 may also be formed, for example, such that using a high reflectance metal as the disk 110, its non-reflective portions are roughened by sputtering or like treatment or applied a low reflectance material, thereby reducing the reflectance of the non-reflective portions. It should be noted, however, that there is no particular limitation to the material of the disk 110 and its method of production.

### 1-4. Optical Module

As shown in FIGS. 3 to 5, the optical module 130 is formed in the form of the substrate BA, which is parallel to the disk 110. The optical module 130 is fixed while facing a part of the slit array SI of the disk 110. Thus, in conjunction with rotation of the disk 110, the optical module 130 is movable relative to the slit array SI in a direction corresponding to the circumferential direction of the disk 110. The optical module 130 includes the optical source 131 and light receiving arrays PI1 and PI2. The optical source 131 and the light receiving arrays PI1 and PI2 are disposed on the surface facing the slit array SI of the substrate BA. While in this embodiment the optical module 130 is formed in the form of the substrate BA, which makes the reflective encoder 100 thin and facilitates production, the optical module 130 may not necessarily be configured in the form of the substrate BA.

The optical source 131 radiates light to a part of the slit array SI (the reflection slits 111) that passes a position that the optical source 131 faces (such part also referred to as a radiated region). While there is no particular limitation to the optical source 131 insofar as the optical source is capable of radiating light to the radiated region, an example that can be used is a LED (Light Emitting Diode). The optical source 131 is formed as a point optical source, where no optical lens or like element is particularly disposed, and radiates diffused light from a light emitting portion. By the point optical source, it is not necessarily meant to be an accurate point. It will be readily appreciated that light can be emitted from a finite surface of an optical source insofar as the optical source is taken as one capable of emitting diffused light from an approximately pointed position in design viewpoints or in operation principle viewpoints. The use of a point optical source in this manner ensures that the optical source 131 radiates diffused light to a part of the slit array SI that passes the position that the optical source 131 faces, thereby approximately uniformly radiating light to this part, even though the optical source 131 is more or less influenced by occurrences such as: a change in amount of light due to displacement from the optical axis; and attenuation due to an optical-path length difference. Additionally, no concentration or diffusion of light is performed by an optical element, and this makes an error or like occurrences by the optical element difficult to occur, and increases straightness of the radiated light to the slit array SI. The optical source 131 has its amount of light emission controlled (adjusted) by an optical source controller 158 (described later) of the position data generator 140, thereby making the amount of light emission an approximately constant value. It should be noted, however, that even such optical source 131 can encounter an offset, making the amount of light emission inconstant, due to the influence of, for example, degradation over time, changes in temperature, and other causes (detailed later).

The light receiving arrays PI1 and PI2 receive reflection light that has been radiated from the optical source 131 and reflected by the reflection slits 111 of the slit array SI that face the optical source 131. For this purpose, each of the light receiving arrays PI1 and PI2, which correspond to the above-described incremental pattern, includes a plurality of photodetectors 123 arranged in a direction corresponding to the circumferential direction of the disk 110. An example of each of the photodetectors 123 that can be used is a PD (Photodiode). It should be noted, however, that the photodetectors 123 will not be limited to a PD, that is, there is no particular limitation to the photodetectors 123 insofar as they are capable of receiving reflection light that has been radiated from the optical source 131 and reflected by the reflection slits 111, and capable of converting the received reflection light into an electrical signal corresponding to the amount of the light that has been received. The light receiving array PI will be described by referring to the light receiving array PI1 taken as an example.

In this embodiment, a set (SET) of four photodetectors 123 in total is arranged in one pitch of the incremental pattern (one pitch as seen in an image projected on the optical module 130), and a plurality of other sets of four photodetectors 123 each are further arranged in the circumferential direction of the disk 110. Since the incremental pattern is a repetition of the reflection slits 111 formed on a one-pitch basis, the photodetectors 123 each generate an electrical signal that is a periodic signal having one period (referred to as 360° in electrical angle) for one pitch, when the disk 110 rotates. Also, since four photodetectors 123 are disposed in one set, which corresponds to one pitch, adjacent photodetectors 123 in one set generate electrical signals that are phase-shifted with respect to one another by 90°.

The incremental pattern indicates positions in one pitch, and the electrical signals of the different phases in one set each exhibit a value that changes in a similar manner with respect to the corresponding one of the electrical signals of the different phases in another set. Thus, the electrical signals of the same phases are added together across the plurality of sets. Thus, four electrical signals that are phase-shifted with respect to each other by 90° are generated from the large number of photodetectors 123 of the light receiving array PI1. The light receiving array PI2 has a similar configuration to that of the light receiving array PI1. Thus, four electrical signals that are phase-shifted with respect to each other by 90° are generated from the light receiving arrays PI1 and PI2. These four electrical signals are referred to as incremental signals, which are occasionally abbreviated incre-signals. Each different one of these electrical signals is referred to as an A phase signal (also referred to as an A+ signal), a B phase signal (which is a signal phase-shifted relative to the A+ signal by 90° and which is also referred to as a B+ signal), an inverse-of-A-phase signal (which is a signal phase-shifted relative to the A+ signal by 180° and which is also referred to as an A− signal), and an inverse-of-B-phase signal (which is a signal phase-shifted relative to the B+ signal by 180° and which is also referred to as a B− signal).

In this embodiment, one set, which corresponds to one pitch of the incremental pattern, has been illustrated as containing four photodetectors 123, and the light receiving array PI1 and the light receiving array PI2 have been illustrated as having a plurality of mutually similar sets. However, there is no particular limitation to the number of the photodetectors 123 in one set, and the light receiving arrays PI1 and PI2 may acquire electrical signals of different phases.

### 1-5. Position Data Generator

As shown in FIG. 3, at a timing when the position x of the motor M is measured, the position data generator 140 acquires from the optical module 130 four incre-signals (the A+ signal, the B+ signal, the A− signal, and the B− signal), which are phase-shifted with respect to each other by 90°. Based on the acquired incre-signals, the position data generator 140 calculates the position x of the motor M indicated by the incre-signals, and outputs position data indicating the position x to the control device CT. There is no particular limitation to the method of generating the position data by the position data generator 140, as there are various methods that can be used. Here, description will be made with regard to an example of calculating the position x of the motor M from the incre-signals and generating the position data.

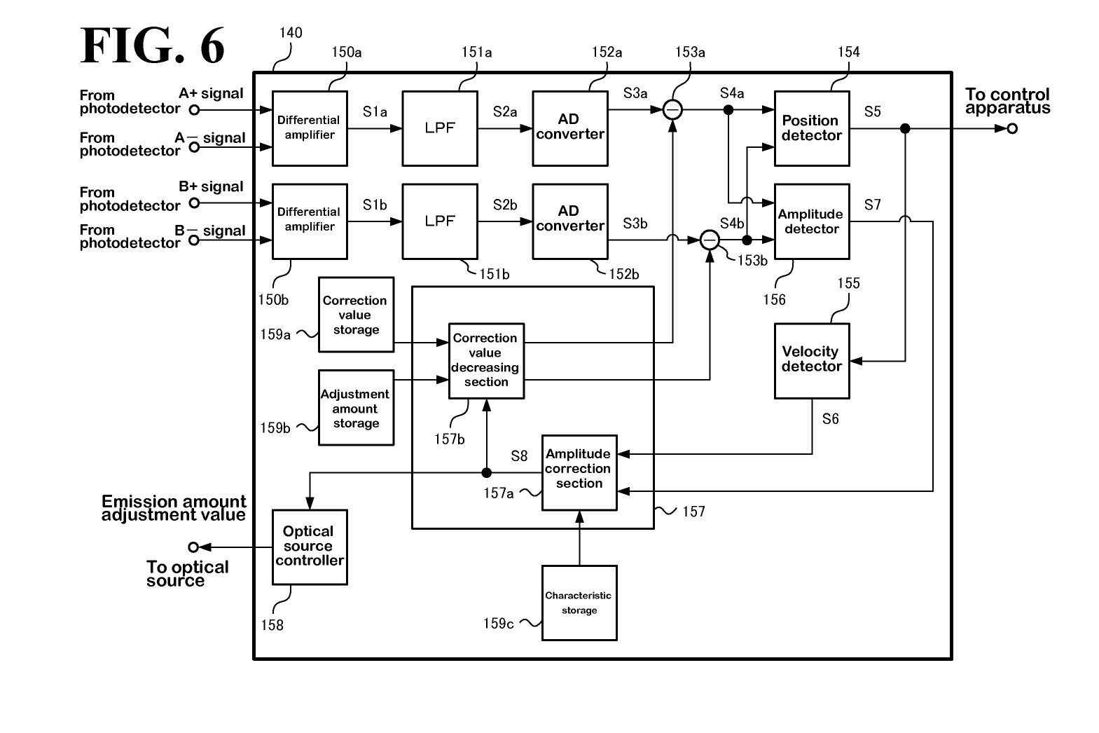

As shown in FIG. 6, the position data generator 140 includes differential amplifiers 150a and 150b, LPFs (Low Pass Filters) 151a and 151b, which are examples of the filter, AD (Analog/Digital) converters 152a and 152b, the subtractors 153a and 153b (examples of the signal corrector), a position detector 154, a velocity detector 155, an amplitude detector 156, an adjustor 157, the optical source controller 158, a correction value storage 159a, an adjustment amount storage 159b, and a characteristic storage 159c.

The correction value storage 159a stores offset correction values used to eliminate offset components, described earlier, contained in electrical signals S3a and S3b (described later), which are based on the above-described incre-signals. The offset correction value stored in the correction value storage 159a is a value (fixed value) obtained and set at the time of, for example, shipment or like occasion based on: the offset components contained in the above-described incre-signals acquired under the condition of a predetermined amount of light radiated from the optical source 131; offsets that occur at the differential amplifiers 150a and 150b; offsets that occur at the LPFs 151a and 151b; and offsets that occur at the AD converters 152a and 152b. The offsets that occur vary among machines, and in view of this, the offset correction value in this embodiment includes an offset correction value used to correct the electrical signal S3a and an offset correction value used to correct the electrical signal S3b.

The differential amplifiers 150a and 150b each receive incre-signals that are 180° out of phase from one another. In this example, the differential amplifier 150a receives the A+ signal and the A− signal, while the differential amplifier 150b receives the B+ signal and the B− signal. The differential amplifier 150a amplifies the difference between the input A+ signal and A− signal using a predetermined differential gain. The amplified electrical signal S1a is input into the LPF 151a. The differential amplifier 150b amplifies the difference between the input B+ signal and B− signal using a predetermined differential gain. The amplified electrical signal S1b is input into the LPF 151b. Thus, amplifying the difference between incre-signals that are 180° out of phase from one another cancels manufacturing errors, measurement errors, and other errors of the reflection slits 111 in one pitch. The differential-amplified electrical signals S1a and S1b are phase-shifted with respect to one another by 90°.

The LPF 151a eliminates (or reduces, which applies in the description that follows) a predetermined high-frequency component contained in the input electrical signal S1a as noise. Here, due to a characteristic of the LPF 151a, the amplitude of the electrical signal S1a is reduced (attenuated) in accordance with an increase in the moving velocity of the disk 110, that is, the rotational velocity of the disk 110 (hereinafter also referred to as a disk velocity). The filtered electrical signal S2a is input into the AD converter 152a. The LPF 151b eliminates (or reduces, which applies in the description that follows) a predetermined high-frequency component contained in the input electrical signal S1b as noise. Here, due to a characteristic of the LPF 151b, the amplitude of the electrical signal S1b is reduced (attenuated) in accordance with an increase in the disk velocity. The filtered electrical signal S2b is input into the AD converter 152b.

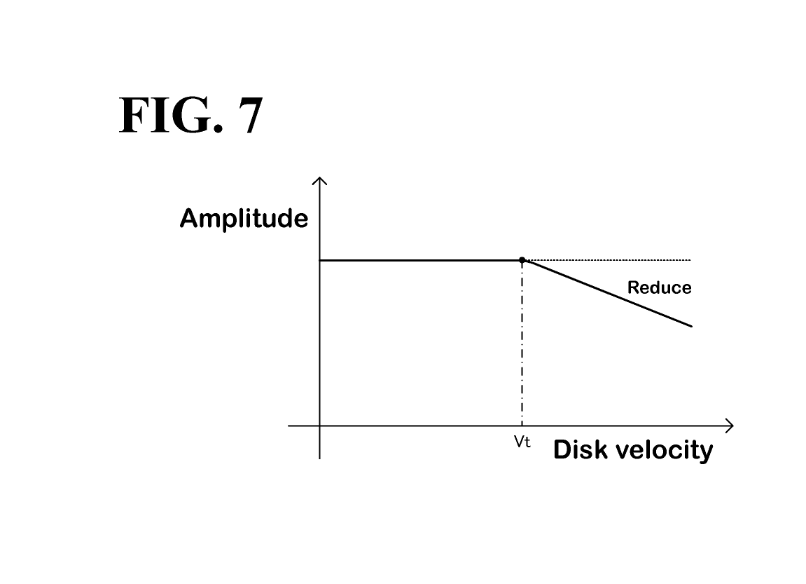

The characteristic storage 159c stores filtering characteristic information indicating characteristics of the LPFs 151a and 151b in a convenient form (examples of the form including a graph, a table, and a function). In this embodiment, the filtering characteristic information that is stored is information that indicates an amplitude relative to the disk velocity indicated by an electrical signal S7 (described later), which is based on the electrical signals S2a and S2b (see FIG. 7, described later).

The AD converter 152a converts the input electrical signal S2a into digital form. The converted electrical signal S3a is input into the subtractor 153a. The AD converter 152b converts the input electrical signal S2b into digital form. The converted electrical signal S3b is input into the subtractor 153b.

The subtractor 153a receives the electrical signal S3a, and in addition, receives an adjusted offset correction value (described later) that is output from a correction value decreasing section 157b (described later) of the adjustor 157 and used to correct the electrical signal S3a. Before the adjustor 157 makes an adjustment described later, the subtractor 153a may receive the same offset correction value as the offset correction value that is used to correct the electrical signal S3a and that is stored in the correction value storage 159a. Then, the subtractor 153a subtracts from the input electrical signal S3a the input offset correction value used to correct the electrical signal S3a, thereby correcting the electrical signal S3a so that its offset component is eliminated. The corrected electrical signal S4a is input into the position detector 154 and also input into the amplitude detector 156. The subtractor 153b receives the electrical signal S3b, and in addition, receives an adjusted offset correction value (described later) that is output from the correction value decreasing section 157b (described later) of the adjustor 157 and that is used to correct the electrical signal S3b. Before the adjustor 157 makes an adjustment described later, the subtractor 153b may receive the same offset correction value as the offset correction value that is used to correct the electrical signal S3b and that is stored in the correction value storage 159a. Then, the subtractor 153b subtracts from the input electrical signal S3b the input offset correction value used to correct the electrical signal S3b, thereby correcting the electrical signal S3b so that its offset component is eliminated. The corrected electrical signal S4b is input into the position detector 154 and also input into the amplitude detector 156, similarly to the electrical signal S4a.

The position detector 154 detects the position in one pitch using the two input electrical signals S4a and S4b. While there is no particular limitation to the method of detecting the position in one pitch, examples of the method of detecting include: to subject division results of the two electrical signals S4a and S4b to an arctangent operation, thereby calculating electrical angles φ; to convert the electrical signals S4a and S4b into electrical angles φ using a tracking circuit; and on a table prepared in advance, to identify electrical angles φ that are related to the values of the electrical signals S4a and S4b. Then, based on the position in one pitch, the position detector 154 generates position data indicating the position x. The generated position data is input as an electrical signal S5 into the control device CT and also input into the velocity detector 155.

The velocity detector 155 detects the disk velocity. While there is no particular limitation to the method of detecting the disk velocity, an example of the method of detecting is to differentiate by time the position x indicated by the input electrical signal S5, thus calculating the disk velocity. The velocity data indicating the detected disk velocity is input as an electrical signal S6 into an amplitude correction section 157a (described later) of the adjustor 157.

The amplitude detector 156 uses the two input electrical signals S4a and S4b to detect an amplitude of the electrical signals S4a and S4b as a whole. While there is no particular limitation to the method of detecting the amplitude of the electrical signals S4a and S4b as a whole, an example of the method of detecting is to calculate a square root of sum of squares of the two electrical signals S4a and S4b (in other words, a radius of the Lissajous figure), thus calculating the amplitude of the electrical signals S4a and S4b as a whole. When the amplitudes of the electrical signals S1a and S1b reduce due to the influence of characteristics of the LPFs 151a and 151b, the amplitude of the electrical signals S4a and S4b as a whole detected here also reduces. The amplitude data indicating the detected amplitude of the electrical signals S4a and S4b as a whole is input as the electrical signal S7 into the amplitude correction section 157a (described later) of the adjustor 157, similarly to the electrical signal S6.

In accordance with the disk velocity indicated by the electrical signal S6 or in accordance with an electrical signal S8 (described later), the adjustor 157 adjusts the amount of light emission or the offset correction value so that the ratio between the amount of light emission and the offset correction value is approximately constant. Specifically, the adjustor 157 makes an adjustment so that the ratio between the amplitude of the electrical signal S3a input into the subtractor 153a and the offset correction value used to correct the electrical signal S3a is approximately constant, in other words, so as to make an approximate match between the amount of the offset component contained in the electrical signal S3a and the offset correction value used to correct the electrical signal S3a. At the same time, the adjustor 157 makes an adjustment so that the ratio between the amplitude of the electrical signal S3b input into the subtractor 153b and the offset correction value used to correct the electrical signal S3b is approximately constant, in other words, so as to make an approximate match between the amount of the offset component contained in the electrical signal S3b and the offset correction value used to correct the electrical signal S3b. The adjustor 157 includes the amplitude correction section 157a and the correction value decreasing section 157b.

The amplitude correction section 157a corrects the influence of characteristics of the LPFs 151a and 151b. Specifically, based on the disk velocity indicated by the input electrical signal S6 and on filtering characteristic information (see FIG. 7, described later) stored in the characteristic storage 159c, the amplitude correction section 157a obtains the amount of reduction in the amplitude that is due to an increase in the disk velocity and that is indicated by the electrical signal S7. Then, the amplitude correction section 157a adds the obtained amount of reduction to the amplitude indicated by the input electrical signal S7, thereby performing the correction of compensating for the reduction in the amplitude that is due to an increase in the disk velocity and that is indicated by the electrical signal S7. When the amount of reduction is 0, the correction amount associated with the above-described correction is 0 (which equals to no correction performed). Amplitude data indicates the corrected amplitude (the correction including the case of 0 correction amount, which applies in the description that follows), and is input as the electrical signal S8 into the optical source controller 158 and also input into the correction value decreasing section 157b. The amplitude indicated by the electrical signal S8 is a value that results from correcting the influence of characteristics of the LPFs 151a and 151b, and thus is a value that corresponds to the amount of light emission. Specifically, when the amount of light emission is a constant value, the amplitude indicated by the electrical signal S8 is a constant value (a predetermined value), while when the amount of light emission changes, the amplitude indicated by the electrical signal S8 changes accordingly. Thus, when the amplitude indicated by the electrical signal S8 is at a predetermined value, the amounts of the offset components contained in the electrical signals S3a and S3b are constant amounts (amounts corresponding to the offset correction values stored in the correction value storage 159a). When the amplitude indicated by the electrical signal S8 changes, the amounts of the offset components contained in the electrical signals S3a and S3b change accordingly.

The optical source controller 158 not only controls the light emission state of the optical source 131, such as whether light is emitted or not emitted, but also controls the amount of light emission. In this embodiment, the optical source controller 158 adjusts, for example, the current (also referred to as a command current) supplied to the optical source 131, thereby controlling the light emission state of the optical source 131. It is also possible to adjust the voltage applied to the optical source 131, so as to control the light emission state of the optical source 131. Further, the optical source controller 158 is capable of accommodating to changes with time in the amount of light emission of the optical source 131 or like occurrences that are due to, for example, degradation over time, changes in temperature, and other causes. Specifically, in accordance with the amplitude of the input electrical signal S8, the optical source controller 158 outputs an emission amount adjustment value to the optical source 131 and controls the amount of light emission so as to make the amount of light emission an approximately constant value, in other words, so as to make the amplitude into the predetermined value (that is, so as to reduce the change in the amplitude). The emission amount adjustment value is for the purpose of adjusting the current (supply current) supplied to the optical source 131, so as to adjust the amount of light emission. Since the optical source controller 158 adjusts the amount of light emission in accordance with the amplitude that is indicated by the electrical signal S8 and that is output from the amplitude correction section 157a, the above-described correction performed by the amplitude correction section 157a can be thought of as an equivalent to adjustment of the amount of light emission.

For example, if the amount of light emission reduces due to degradation of the optical source 131, the amplitude indicated by the electrical signal S8 reduces accordingly. In this case, the optical source controller 158 increases the supply current to the optical source 131 and thus inhibits the reduction in the amount of light emission so as to make this amplitude into the predetermined value. It should be noted, however, that there is an upper limit to the current that can be supplied to the optical source 131, and the optical source controller 158 has a predetermined control range for its light emission amount control. Thus, when degradation of the optical source 131 progresses and the supply current to the optical source 131 reaches the upper limit (when the control range of the light emission amount control by the optical source controller 158 becomes saturated), from now on the light emission amount control by the optical source controller 158 cannot inhibit the reduction in the amount of light emission, allowing the amount of light emission to reduce. Accordingly, the amplitude indicated by the electrical signal S8 reduces, and the amounts of the offset components contained in the electrical signals S3a and S3b reduce. Changes in the supply current to the optical source 131, in the amount of light emission, and in the amounts of the offset components contained in the electrical signals S3a and S3b after the optical source 131 has degraded will be described later.

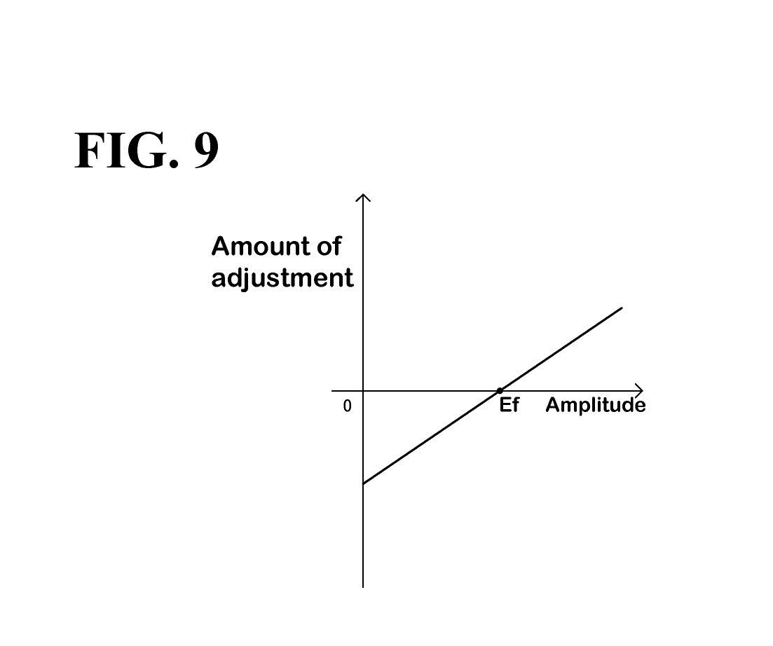

The adjustment amount storage 159b stores, in a convenient form (examples of the form including a graph, a table, and a function), adjustment amount information indicating the amount of adjustment of the offset correction values, relative to the amount of light emission of the optical source 131, that are stored in the correction value storage 159a. In this embodiment, the adjustment amount information that is stored is information that indicates the amount of adjustment of the offset correction values, relative to the amplitude indicated by the electrical signal S8, that are stored in the correction value storage 159a (see FIG. 9, described later).

Based on the amplitude indicated by the input electrical signal S8 and on the adjustment amount information stored in the adjustment amount storage 159b (see FIG. 9, described later), the correction value decreasing section 157b detects the amount of adjustment corresponding to this amplitude. The optical source controller 158 has a higher processing velocity than that of the correction value decreasing section 157b, and the amplitude that is indicated by the electrical signal S8 and that is referenced by the correction value decreasing section 157b is at a value corresponding to the above-described incre-signals acquired after the optical source controller 158 has performed its light emission amount control. That is, the amplitude that is indicated by the electrical signal S8 and that is referenced by the correction value decreasing section 157b remains at the predetermined value even under the influence of characteristics of the LPFs 151a and 151b or the influence of degradation of the optical source 131. It should be noted, however, that when the control range of the light emission amount control by the optical source controller 158 is saturated, the amplitude that is indicated by the electrical signal S8 and that is referenced by the correction value decreasing section 157b is at a value smaller than the predetermined value. Then, the correction value decreasing section 157b adds the detected amount of adjustment to the offset correction values stored in the correction value storage 159a, thereby performing the adjustment of making the offset correction values match the reductions in the amounts of the offset components contained in the electrical signals S3a and S3b associated with saturation of the control range of the light emission amount control by the optical source controller 158, and thus reducing the offset correction values. Thus, the offset correction value used to correct the electrical signal S3a is made to approximately match the amount of the offset component contained in the electrical signal S3a, while the offset correction value used to correct the electrical signal S3b is made to approximately match the amount of the offset component contained in the electrical signal S3b. When the amplitude indicated by the electrical signal S8 is at the predetermined value, the amount of adjustment is 0 (which equals to no adjustment performed). The adjusted offset correction value used to correct the electrical signal S3a (the adjustment including the case of 0 adjustment amount, which applies in the description that follows) is input into the subtractor 153a, while the adjusted offset correction value used to correct the electrical signal S3b is input into the subtractor 153b.

Next, by referring to FIG. 7, the filtering characteristic information will be described.

FIG. 7 is a graph of an example of the filtering characteristic information with the disk velocity on the horizontal axis and the amplitude indicated by the electrical signal S7 on the vertical axis. In the example shown in the graph, the amplitude indicated by the electrical signal S7 is maintained at an approximately constant value until the disk velocity reaches the predetermined velocity threshold Vₜ. Once the disk velocity exceeds the velocity threshold Vₜ, as the disk velocity increases, the amplitude indicated by the electrical signal S7 reduces. It should be noted, however, that the filtering characteristic information will not be limited to this graph.

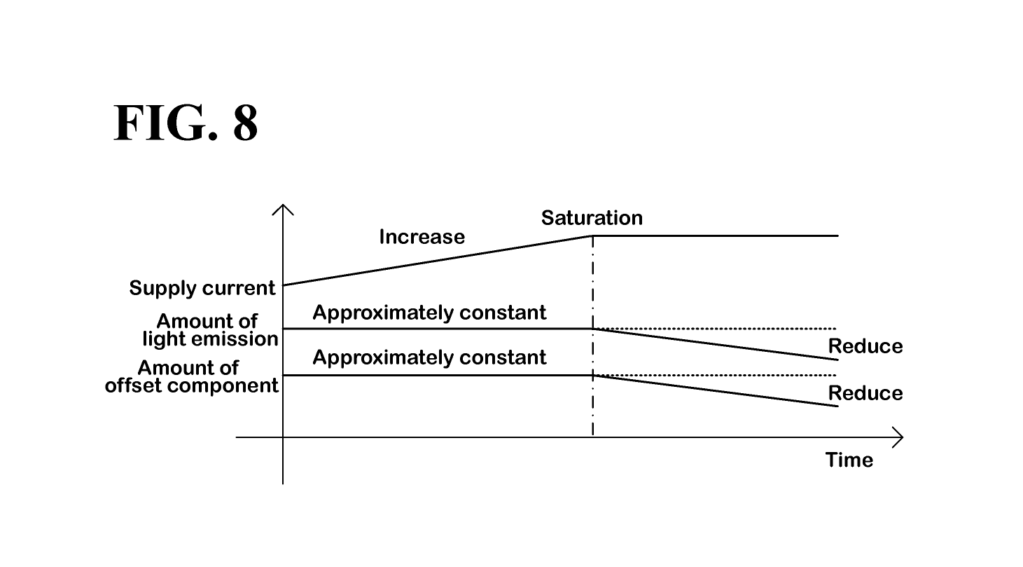

Next, by referring to FIG. 8, description will be made with regard to changes in the supply current to the optical source 131, in the amount of light emission, and in the amounts of the offset components contained in the electrical signals S3a and S3b after the optical source 131 has degraded.

FIG. 8 is a graph of changes in the supply current to the optical source 131, in the amount of light emission, and in the amounts of the offset components contained in the electrical signals S3a and S3b after the optical source 131 has degraded. Time is on the horizontal axis, and the supply current to the optical source 131, the amount of light emission, and the amounts of the offset components contained in the electrical signals S3a and S3b are on the vertical axis. As the graph indicates, until the supply current reaches saturation, the supply current increases as degradation of the optical source 131 proceeds (as time elapses), while the amount of light emission and the amounts of the offset components are maintained at approximately constant amounts. Once the supply current becomes saturated, the amount of light emission and the amount of the offset components reduce as degradation of the optical source 131 proceeds (as time elapses).

Next, by referring to FIG. 9, the adjustment amount information will be described.

FIG. 9 is a graph of an example of the adjustment amount information with the amplitude indicated by the electrical signal S8 on the horizontal axis and the amount of adjustment on the vertical axis. In the example shown in the graph, when the amplitude indicated by the electrical signal S8 is at a predetermined value E_{f}, the amount of adjustment is 0. Then, as the amplitude indicated by the electrical signal S8 increases from the predetermined value E_{f}, the amount of adjustment increases proportionally, while as the amplitude indicated by the electrical signal S8 reduces from the predetermined value E_{f}, the amount of adjustment reduces proportionally. It should be noted, however, that the adjustment amount information will not be limited to this graph.

In this embodiment, those stored are: offset correction values resulting under the condition of a predetermined amount of light radiated from the optical source 131; and adjustment amount information indicating the amount of adjustment of the offset correction values relative to the amplitude indicated by the electrical signal S8. Then, the correction value decreasing section 157b detects the amount of adjustment corresponding to this amplitude, thereby adjusting the offset correction values to make them correspond to the amplitude. This, however, should not be construed in a limiting sense. For example, it is also possible to store information indicating offset correction values relative to the amplitude indicated by the electrical signal S8 and to have the correction value decreasing section 157b adjust the offset correction values based on this amplitude so as to make them correspond to the amplitude.

### 1-6. Operations of the Position Data Generator

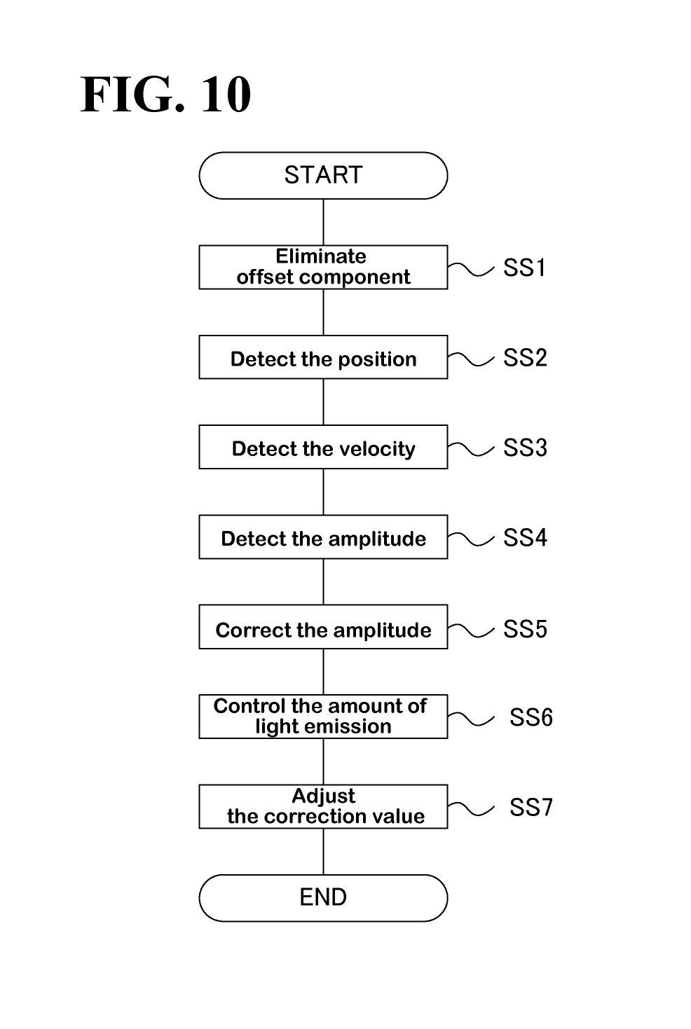

Next, by referring to FIG. 10, description will be made with regard to an example of the operations of the position data generator 140 according to this embodiment that are based on a method of signal processing by the reflective encoder 100.

Referring to FIG. 10, at step SS1, the position data generator 140 at its subtractor 153a subtracts the input offset correction value used to correct the electrical signal S3a from the input electrical signal S3a, thereby eliminating the offset component contained in the electrical signal S3a and generating the electrical signal S4a. The generated electrical signal S4a is input into the position detector 154 and also input into the amplitude detector 156. At the same time, at step SS1, the position data generator 140 at its subtractor 153b subtracts the input offset correction value used to correct the electrical signal S3b from the input electrical signal S3b, thereby eliminating the offset component contained in the electrical signal S3b and generating the electrical signal S4b. The generated electrical signal S4b is input into the position detector 154 and also input into the amplitude detector 156.

Then, at step SS2, the position data generator 140 at its position detector 154 uses the two input electrical signals S4a and S4b to generate position data indicating the position x. The generated position data is input as the electrical signal S5 into the control device CT and also input into the velocity detector 5.

Then, at step SS3, the position data generator 140 at its velocity detector 155 uses the input electrical signal S5 to detect the disk velocity, and generates velocity data indicating the detected disk velocity. The generated velocity data is input as the electrical signal S6 into the amplitude correction section 157a of the adjustor 157.

Then, at step SS4, the position data generator 140 at its amplitude detector 156 uses the two input electrical signals S4a and S4b to detect an amplitude of the electrical signals S4a and S4b as a whole, and generates amplitude data indicating the detected amplitude. The generated amplitude data is input as the electrical signal S7 into the amplitude correction section 157a of the adjustor 157.

Then, at step SS5, based on the disk velocity indicated by the input electrical signal S6 and on the filtering characteristic information stored in the characteristic storage 159c (see FIG. 7), the position data generator 140 at its amplitude correction section 157a obtains the amount of reduction in the amplitude indicated by the electrical signal S7 that is due to an increase in the disk velocity. Then, the position data generator 140 at its amplitude correction section 157a adds the obtained amount of reduction to the amplitude indicated by the input electrical signal S7, thereby performing the correction of compensating for the reduction in the amplitude indicated by the electrical signal S7 that is due to the increase in the disk velocity.

For example, when the amplitude indicated by the electrical signal S7 reduces in accordance with an increase in the disk velocity (when, in the example shown in FIG. 7, the disk velocity is in excess of its velocity threshold Vₜ), then at step SS5, the obtained amount of reduction is higher than 0, and the above-described correction is by adding this amount of reduction to the amplitude indicated by the electrical signal S7, followed by generation of amplitude data indicating the corrected amplitude. For another example, when the amplitude indicated by the electrical signal S7 is not reduced (when, in the example shown in FIG. 7, the disk velocity is short of reaching its velocity threshold Vₜ), then at step SS5, the obtained amount of reduction is 0 and substantially no correction is performed, resulting in generation of amplitude data indicating the same amplitude as the amplitude indicated by the electrical signal S7. The generated amplitude data is input as the electrical signal S8 into the optical source controller 158 and also input into the correction value decreasing section 157b.

Then, at step SS6, in accordance with the amplitude of the input electrical signal S8, the position data generator 140 at its optical source controller 158 outputs the emission amount adjustment value to the optical source 131 and thus controls the amount of light emission so as to make this amplitude into the predetermined value.

For example, when the amplitude indicated by the electrical signal S8 is smaller than the predetermined value, then at step SS6, the position data generator 140 at its optical source controller 158 increases the supply current to the optical source 131 and thus inhibits a reduction in the amount of light emission so as to make this amplitude into the predetermined value. For another example, when the amplitude indicated by the electrical signal S8 is at the predetermined value, then at step SS6, the position data generator 140 at its optical source controller 158 maintains the supply current to the optical source 131 and thus maintains the amount of light emission so as to make this amplitude maintained at the predetermined value.

Then, at step SS7, based on the amplitude indicated by the input electrical signal S8 and on the adjustment amount information stored in the adjustment amount storage 159b (see FIG. 9), the position data generator 140 at its correction value decreasing section 157b detects the amount of adjustment corresponding to this amplitude. As described above, the amplitude that is indicated by the electrical signal S8 and that is referenced by the correction value decreasing section 157b is at a value corresponding to the above-described incre-signals acquired after the optical source controller 158 has performed its light emission amount control. Then, the position data generator 140 at its correction value decreasing section 157b adds the detected amount of adjustment to the offset correction values stored in the correction value storage 159a, thereby performing the adjustment of making the offset correction values match the reductions in the amounts of the offset components contained in the electrical signals S3a and S3b associated with saturation of the control range of the light emission amount control by the optical source controller 158, and thus reducing the offset correction values.

For example, there is the case where the amplitude indicated by the electrical signal S8 is smaller than the predetermined value (where, in the example shown in FIG. 9, this amplitude is at a value smaller than the predetermined value E_{f}). In this case, at step SS7, the detected amount of adjustment is at a negative value. Then, this amount of adjustment (the negative value) is added to the offset correction values stored in the correction value storage 159a, and thus the offset correction values are reduced so as to make them approximately match the amounts of the offset components that have been reduced in conjunction with the reduction in the amount of light emission. Then, the adjusted offset correction values are input into the subtractors 153a and 153b. In this case, at step SS1, which is described above and again later, the position data generator 140 at its subtractors 153a and 153b subtracts the adjusted offset correction values from the electrical signals S3a and S3b corresponding to the amount of light emission that has been reduced as described above, thereby eliminating the offset components. For another example, there is the case where the amplitude indicated by the electrical signal S8 is at the predetermined value (where, in the example shown in FIG. 9, this amplitude is at the predetermined value E_{f}). In this case, at step SS7, the detected amount of adjustment is 0, and substantially no adjustment is performed, with the result that the same offset correction values as the offset correction values stored in the correction value storage 159a are input into the subtractors 153a and 153b as adjusted offset correction values. In this case, at step SS1, which is described above and again later, the position data generator 140 at its subtractors 153a and 153b subtracts the adjusted offset correction values from the electrical signals S3a and S3b corresponding to a predetermined amount of light, thereby eliminating the offset components.

### 1-7. Exemplary Advantageous Effects of the First Embodiment

The first embodiment has been described. In this embodiment, in accordance with the disk velocity or the amplitude indicated by the electrical signal S8, the adjustor 157 adjusts the amplitude indicated by the electrical signal S8 or the offset correction values stored in the correction value storage 159a so that the ratios between the amplitudes of the electrical signals S3a and S3b respectively input into the subtractors 153a and 153b and the offset correction values are approximately constant. Thus, the subtractors 153a and 153b respectively correct, using the offset correction values stored in the correction value storage 159a, the electrical signals S3a and S3b corresponding to the amount of light emission adjusted by the adjustor 157 into a predetermined amount of light, or the subtractors 153a and 153b respectively correct the electrical signals S3a and S3b using offset correction values adjusted by the adjustor 157 into agreement with the amounts of the offset components contained in the electrical signals S3a and S3b. This ensures that the offset components are sufficiently eliminated. This, as a result, ensures further inhibiting an offset of the amount of light emission or adjusting the offset correction values in accordance with the offset of the amount of light emission, thereby reliably improving detection accuracy in detecting the position of the motor M.

It is particularly noted that in this embodiment, when the disk velocity increases and the amplitude indicated by the electrical signal S7 reduces as described above, the adjustor 157 adjusts the amplitude indicated by the electrical signal S8 in accordance with an increase in the disk velocity, or adjusts the offset correction values stored in the correction value storage 159a into values corresponding to the amount of light emission (the amplitude indicated by the electrical signal S8) so that the ratios between the amplitudes of the electrical signals S3a and S3b respectively input into the subtractors 153a and 153b and the offset correction values are approximately constant. This ensures that the real amounts of the offset components contained in the electrical signals S3a and S3b have no or minimal discrepancies with the respective offset correction values input into the subtractors 153a and 153b, and ensures more accurate detection of the position of the motor M.

### Advantageous Effects by the Amplitude Correction Section

It is particularly noted that in this embodiment, the amplitude correction section 157a performs the correction of compensating for a reduction, due to an increase in the disk velocity, in the amplitude indicated by the electrical signal S7 based on the disk velocity indicated by the electrical signal S6 and the filtering characteristic information stored in the characteristic storage 159c. Then, in accordance with the amplitude indicated by the electrical signal S8 corrected by the amplitude correction section 157b, the optical source controller 158 controls the amount of light emission so as to make this amplitude into a predetermined value. Thus, the subtractors 153a and 153b respectively correct, using the offset correction values stored in the correction value storage 159a, the electrical signals S3a and S3b corresponding to the amount of light emission that has been controlled by the optical source controller 158, thereby sufficiently eliminating the offset components. This, as a result, sufficiently eliminates the offset components even when the disk velocity increases, thereby reliably improving detection accuracy in detecting the position of the motor M.

### Advantageous Effects by the Correction Value Decreasing Section

It is particularly noted that in this embodiment, when the amplitude indicated by the electrical signal S8 reduces in spite of the light emission amount control that has been performed by the optical source controller 158, the correction value decreasing section 157b performs the adjustment of reducing the offset correction values stored in the correction value storage 159a based on this amplitude and the adjustment amount information stored in the adjustment amount storage 159b. Thus, the subtractors 153a and 153b respectively correct, using the offset correction values adjusted by the correction value decreasing section 157b, the electrical signals S3a and S3b corresponding to the reduced amount of light emission, thereby sufficiently eliminating the offset components. This, as a result, sufficiently eliminates the offset components even when, for example, the light emission amount control of the optical source controller 158 is not enough to compensate for the reduction in the amount of light emission, allowing the amount of light emission to reduce. This reliably improves detection accuracy in detecting the position of the motor M.

### 2. Second Embodiment

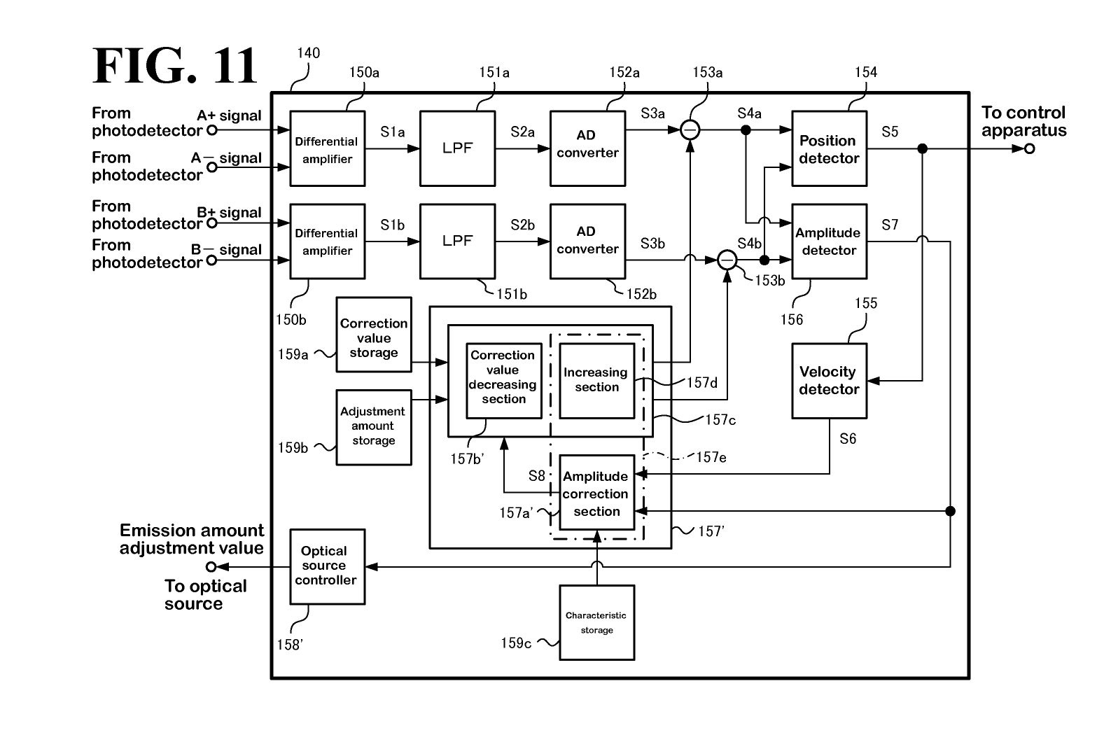

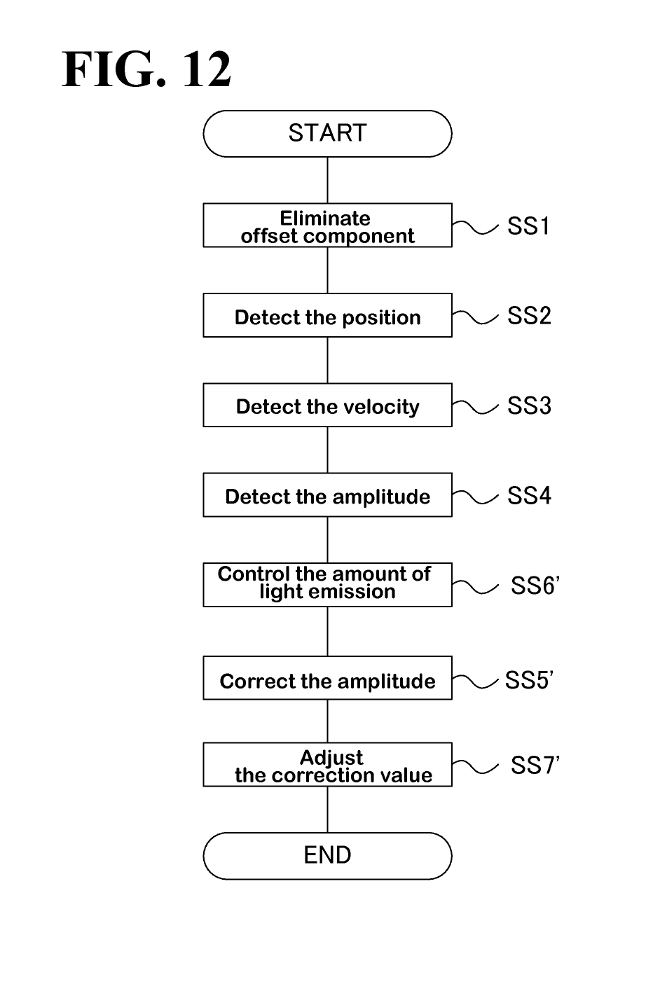

Next, by referring to FIGS. 11 and 12, a second embodiment will be described. Like reference numerals designate corresponding or identical elements throughout the first and second embodiments, and therefore such elements will not be further elaborated in the following description.

A servo system S according to this embodiment is different from the first embodiment in the position data generator 140. The servo system S is otherwise approximately similar to the first embodiment and will not be further elaborated here.

### 2-1. Position Data Generator

By referring to FIG. 11, the position data generator 140 according to this modification will be described below. FIG. 11 corresponds to FIG. 6.

As shown in FIG. 11, the position data generator 140 according to this embodiment has an approximately similar configuration to the corresponding one of the first embodiment. It should be noted, however, that the position data generator 140 according to this embodiment includes an adjustor 157′ and an optical source controller 158′ instead of the adjustor 157 and optical source controller 158.

Also in this embodiment, the electrical signal S7 output from the amplitude detector 156 is input into the optical source controller 158′ and also input into an amplitude correction section 157a′ (described later) of the adjustor 157′.

The optical source controller 158′ basically performs similar processing to that of the optical source controller 158. It should be noted, however, that in accordance with the amplitude of the input electrical signal S7, the optical source controller 158′ according to this embodiment outputs the emission amount adjustment value to the optical source 131 so as to make the amount of light emission into an approximately constant value, in other words, so as to make this amplitude into a predetermined value (so as to reduce the change in the amplitude), thereby controlling the amount of light emission.

For example, due to characteristics of the LPFs 151a and 151b, the amplitude indicated by the electrical signal S7 reduces in accordance with an increase in the disk velocity. In this case, the optical source controller 158′ increases the supply current to the optical source 131 and increases the amount of light emission so as to make this amplitude into the predetermined value. Although this makes the amplitude indicated by the electrical signal S7 into the predetermined value, the increase in the amount of light emission involves an increase in the amounts of the offset components contained in the electrical signals S3a and S3b. Additionally, if the amount of light emission reduces due to degradation of the optical source 131, the amplitude indicated by the electrical signal S7 reduces accordingly. In this case, the optical source controller 158′ increases the supply current to the optical source 131 and controls the amount of light emission so as to make this amplitude into the predetermined value. It should be noted, however, that when degradation of the optical source 131 proceeds and the supply current to the optical source 131 reaches the upper limit (when the control range of the light emission amount control by the optical source controller 158′ becomes saturated), from now on the light emission amount control by the optical source controller 158′ cannot inhibit the reduction in the amount of light emission, allowing the amount of light emission to reduce. Accordingly, the amplitude indicated by the electrical signal S7 reduces, and the amounts of the offset components contained in the electrical signals S3a and S3b reduce.

In accordance with the disk velocity indicated by the electrical signal S6 or in accordance with the electrical signal S8, the adjustor 157′ adjusts the offset correction value so that the ratio between the amount of light emission and the offset correction value is approximately constant. Specifically, the adjustor 157′ adjusts the offset correction value so as to make an approximate match between the amount of the offset component contained in the electrical signal S3a, which is input into the subtractor 153a, and the offset correction value used to correct the electrical signal S3a. At the same time, the adjustor 157′ adjusts the offset correction value so as to make an approximate match between the amount of the offset component contained in the electrical signal S3b, which is input into the subtractor 153b, and the offset correction value used to correct the electrical signal S3b. The adjustor 157′ includes the amplitude correction section 157a′ and the correction value adjustment section 157c.

The amplitude correction section 157a′ performs substantially similar processing to that of the amplitude correction section 157a. The optical source controller 158′ has a higher processing velocity than that of the amplitude correction section 157a′, and the amplitude that is indicated by the electrical signal S7 and that is referenced by the amplitude correction section 157a′ is at a value corresponding to the above-described incre-signals acquired after the optical source controller 158′ has performed its light emission amount control. That is, the amplitude that is indicated by the electrical signal S7 and that is referenced by the amplitude correction section 157a′ remains at the predetermined value even under the influence of characteristics of the LPFs 151a and 151b or the influence of degradation of the optical source 131. It should be noted, however, that when the control range of the light emission amount control by the optical source controller 158′ is saturated, the amplitude that is indicated by the electrical signal S7 and that is referenced by the amplitude correction section 157a′ is at a value smaller than the predetermined value. Amplitude data indicates the amplitude that has been corrected by the amplitude correction section 157a′ (the correction including the case of 0 correction amount, which applies in the description that follows), and is input as the electrical signal S8 into the correction value adjustment section 157c.

The correction value adjustment section 157c is a section to adjust the offset correction values stored in the correction value storage 159a in accordance with the amplitude indicated by the input electrical signal S8, and includes an increasing section 157d and a correction value decreasing section 157b′. The amplitude correction section 157a′ and the increasing section 157d constitute a correction value increasing section 157e. Based on the amplitude indicated by the input electrical signal S8 and on the adjustment amount information stored in the adjustment amount storage 159b (see FIG. 9), the correction value adjustment section 157c detects the amount of adjustment corresponding to this amplitude. Here, when the detected amount of adjustment is at a positive value, the increasing section 157d adds the amount of adjustment (the positive value) to the offset correction values stored in the correction value storage 159a, thereby performing the adjustment of making the offset correction values match the increases in the amounts of the offset components contained in the electrical signals S3a and S3b associated with the amount of light emission increased by the optical source controller 158′ for the purpose of correcting the influence of characteristics of the LPFs 151a and 151b, and thus increasing the offset correction values. When the detected amount of adjustment is at a negative value, the correction value decreasing section 159b′ adds the amount of adjustment (the negative value) to the offset correction values stored in the correction value storage 159a, thereby performing the adjustment of making the offset correction values match the reductions in the amounts of the offset components contained in the electrical signals S3a and S3b associated with saturation of the control range of the light emission amount control by the optical source controller 158′, and thus reducing the offset correction values. Thus, the offset correction value used to correct the electrical signal S3a is made to approximately match the amount of the offset component contained in the electrical signal S3a, while the offset correction value used to correct the electrical signal S3b is made to approximately match the amount of the offset component contained in the electrical signal S3b. When the amplitude indicated by the electrical signal S8 is at the predetermined value, the amount of adjustment is 0 (which equals to no adjustment performed). The offset correction value that is used to correct the electrical signal S3a and that has been adjusted by the correction value adjustment section 157c (the adjustment including the case of 0 adjustment amount, which applies in the description that follows) is input into the subtractor 153a, while the adjusted offset correction value used to correct the electrical signal S3b is input into the subtractor 153b.

Thus, the subtractor 153a receives the electrical signal S3a and also receives the adjusted offset correction value that is used to correct the electrical signal S3a and that is output from the correction value adjustment section 157c. Then, similarly to the first embodiment, the subtractor 153a subtracts the input offset correction value used to correct the electrical signal S3a from the input electrical signal S3a, thereby performing the correction of eliminating the offset component from the electrical signal S3a. The subtractor 153b receives the electrical signal S3b and also receives the adjusted offset correction value that is used to correct the electrical signal S3b and that is output from the correction value adjustment section 157c. Then, similarly to the first embodiment, the subtractor 153b subtracts the input offset correction value used to correct the electrical signal S3b from the input electrical signal S3b, thereby performing the correction of eliminating the offset component from the electrical signal S3b.

The configurations and functions of the other elements of the position data generator 140 than those described here are approximately similar to those in the first embodiment, and will not be further elaborated here. 62-2. Operations of the Position Data Generator

Next, by referring to FIG. 12, description will be made with regard to an example of the operations of the position data generator 140 according to this embodiment that are based on the method of signal processing by the reflective encoder 100. FIG. 12 corresponds to FIG. 10.

In FIG. 12, steps SS1 to SS4 are similar to those in FIG. 10. It should be noted, however, that at step SS3 in this embodiment, the velocity data generated at the velocity detector 155 is input as the electrical signal S6 into the amplitude correction section 157a′ of the adjustor 157′. Additionally, at step SS4, the amplitude data generated at the amplitude detector 156 is input as the electrical signal S7 into the optical source controller 158′ and also input into the amplitude correction section 157a′ of the adjustor 157′.

Then, at step SS6′, in accordance with the amplitude of the input electrical signal S7, the position data generator 140 at its optical source controller 158′ outputs the emission amount adjustment value to the optical source 131 and thus controls the amount of light emission so as to make this amplitude into the predetermined value.

For example, when the amplitude indicated by the electrical signal S7 is smaller than the predetermined value, then at step SS6′, the position data generator 140 at its optical source controller 158′ increases the supply current to the optical source 131 and thus inhibits a reduction in the amount of light emission so as to make this amplitude into the predetermined value. For another example, when the amplitude indicated by the electrical signal S7 is at the predetermined value, then at step SS6′, the position data generator 140 at its optical source controller 158′ maintains the supply current to the optical source 131 and thus maintains the amount of light emission so as to make this amplitude maintained at the predetermined value.

Then, at step SS5′, based on the disk velocity indicated by the input electrical signal S6 and on the filtering characteristic information stored in the characteristic storage 159c (see FIG. 7), the position data generator 140 at its amplitude correction section 157a′ obtains the amount of reduction in the amplitude indicated by the electrical signal S7 that is due to an increase in the disk velocity. As described above, the amplitude that is indicated by the electrical signal S7 and that is referenced by the amplitude correction section 157a′ is at a value corresponding to the above-described incre-signals acquired after the optical source controller 158′ has performed its light emission amount control. Then, the position data generator 140 at its amplitude correction section 157a′ adds the obtained amount of reduction to the amplitude indicated by the input electrical signal S7, thereby performing the correction of compensating for the reduction in the amplitude indicated by the electrical signal S7 that is due to the increase in the disk velocity. The generated amplitude data is input as the electrical signal S8 into the correction value adjustment section 157c.

Then, at step SS7, based on the amplitude indicated by the input electrical signal S8 and on the adjustment amount information stored in the adjustment amount storage 159b (see FIG. 9), the position data generator 140 at its correction value adjustment section 157c detects the amount of adjustment corresponding to this amplitude. Then, the position data generator 140 at its correction value adjustment section 157c adds the detected amount of adjustment to the offset correction values stored in the correction value storage 159a, thereby adjusting the offset correction values to make the offset correction values match the amounts of the offset components contained in the electrical signals S3a and S3b.

For example, when the amplitude indicated by the electrical signal S8 is higher than the predetermined value (when, in the example shown in FIG. 9, this amplitude is at a value higher than the predetermined value E_{f}). In this case, at step SS7′, the detected amount of adjustment is at a positive value. In this case, the increasing section 157d adds the amount of adjustment (the positive value) to the offset correction values stored in the correction value storage 159a, thereby increasing the offset correction values so as to make them approximately match the amounts of the offset components that have been increased in conjunction with the increase in the amount of light emission. Then, the adjusted offset correction values are input into the subtractors 153a and 153b. In this case, at step SS1, which is described above and again later, the position data generator 140 at its subtractors 153a and 153b subtracts the adjusted offset correction values from the electrical signals S3a and S3b corresponding to the amount of light emission that has been increased in the above-described manner, thereby eliminating the offset components. For another example, there is the case where the amplitude indicated by the electrical signal S8 is smaller than the predetermined value (where, in the example shown in FIG. 9, this amplitude is at a value smaller than the predetermined value E_{f}). In this case, at step SS7′, the detected amount of adjustment is at a negative value. In this case, the correction value decreasing section 157b′ adds the amount of adjustment (the negative value) to the offset correction values stored in the correction value storage 159a, thereby reducing the offset correction values so as to make them approximately match the amounts of the offset components that have been reduced in conjunction with the reduction in the amount of light emission. Then, the adjusted offset correction values are input into the subtractors 153a and 153b. In this case, at step SS1, which is described above and again later, the position data generator 140 at its subtractors 153a and 153b subtracts the adjusted offset correction values from the electrical signals S3a and S3b corresponding to the amount of light emission that has been reduced in the above-described manner, thereby eliminating the offset components. For another example, there is the case where the amplitude indicated by the electrical signal S8 is at the predetermined value (where, in the example shown in FIG. 9, this amplitude is at the predetermined value E_{f}). In this case, at step SS7′, the detected amount of adjustment is 0, and substantially no adjustment is performed, with the result that the same offset correction values as the offset correction values stored in the correction value storage 159a are input into the subtractors 153a and 153b as adjusted offset correction values. In this case, at step SS1, which is described above and again later, the position data generator 140 at its subtractors 153a and 153b subtracts the adjusted offset correction values from the electrical signals S3a and S3b corresponding to a predetermined amount of light, thereby eliminating the offset components.

### 2-3. Exemplary Advantageous Effects of the Second Embodiment

In this embodiment as described hereinbefore, in accordance with the amplitude indicated by the electrical signal S8, the adjustor 157′ adjusts the offset correction values stored in the correction value storage 159a into values corresponding to the amount of light emission (the amplitude indicated by the electrical signal S8) so that the ratios between the amplitudes of the electrical signals S3a and S3b respectively input into the subtractors 153a and 153b and the offset correction values are approximately constant. Thus, the subtractors 153a and 153b respectively correct the electrical signals S3a and S3b using the offset correction values adjusted by the adjustor 157′, thereby sufficiently eliminating the offset components. This, as a result, ensures adjusting the offset correction values in accordance with changes in the offset components, and ensures more accurate detection of the position of the motor M.

### Advantageous Effects by the Correction Value Decreasing Section

Also in this embodiment, when the amplitude indicated by the electrical signal S8 reduces in spite of the light emission amount control that has been performed by the optical source controller 158′, the correction value decreasing section 157b′ performs the adjustment of reducing the offset correction values stored in the correction value storage 159a based on this amplitude and the adjustment amount information stored in the adjustment amount storage 159b. Thus, the subtractors 153a and 153b respectively correct, using the offset correction values adjusted by the correction value decreasing section 157b′, the electrical signals S3a and S3b corresponding to the reduced amount of light emission, thereby sufficiently eliminating the offset components. This, as a result, sufficiently eliminates the offset components even when, for example, the light emission amount control of the optical source controller 158′ is not enough to compensate for the reduction in the amount of light emission, allowing the amount of light emission to reduce. This reliably improves detection accuracy in detecting the position of the motor M.

### Advantageous Effects by the Correction Value Increasing Section

Also in this embodiment, when the amplitude indicated by the electrical signal S7 reduces due to an increase in the disk velocity, causing the optical source controller 158′ to increase the amount of light emission, then the correction value increasing section 157e performs the adjustment of increasing the offset correction values stored in the correction value storage 159a based on the disk velocity indicated by the electrical signal S6 and on the filtering characteristic information stored in the characteristic storage 159c. Thus, the subtractors 153a and 153b respectively correct, using the offset correction values adjusted by the correction value increasing section 157e, the electrical signals S3a and S3b corresponding to the amount of light emission that has been increased by the optical source controller 158′, thereby sufficiently eliminating the offset components. This, as a result, sufficiently eliminates the offset components even when the disk velocity increases, thereby reliably improving detection accuracy in detecting the position of the motor M.

### 3. Modifications

Two embodiments have been described in detail. It will be readily appreciated, however, that the technical scope of the present invention will not be limited the embodiments described herein. Various modifications, alterations, and combinations of the embodiments will be apparent to those skilled in the art to which the present invention belongs without departing from the scope and spirit of the present invention. Therefore, the present invention is to cover all modifications, alterations, and combinations that fall within the spirit and scope of the present invention as defined by the appended claims. Modifications will be described below.

While in the first embodiment the adjustor 157 includes the amplitude correction section 157a and the correction value decreasing section 157b, this should not be construed in a limiting sense. The adjustor 157 may include one of the foregoing elements. While in the second embodiment the adjustor 157′ includes the correction value increasing section 157e and the correction value decreasing section 157b′, this should not be construed in a limiting sense. The adjustor 157′ may include one of the foregoing elements.

While in the above description only the slit array SI having an incremental pattern is formed on the disk 110, it is also possible to form a slit array having a serial absolute pattern. In this case, a light receiving array having a plurality of photodetectors may be disposed on the substrate BA to receive reflection light from the reflection slits of the slit array having the serial absolute pattern, thereby detecting the absolute position (absolute angle) of the disk 110.

While the reflective encoder 100 used as an example in the above description has the optical source 131 and the photodetectors 123 disposed on the substrate BA of the optical module 130, this should not be construed in a limiting sense. It is also possible to use what is called a transmission type encoder, in which the optical source 131 is opposed to the photodetectors across the disk. In this case, transmission slits may be formed on the disk 110, and this enables the photodetectors to receive light radiated from the optical source 131 through the transmission slits formed on the disk, and to generate electrical signals corresponding to the amount of the received light. The use of such transmission type encoder provides similar advantageous effects to those obtained in the above-described embodiments and modifications.

While in the above description the servo motor SM is used as an example, this should not be construed in a limiting sense. It is also possible to use another kind of motor apparatus. The use of such another kind of motor apparatus provides similar advantageous effects to those obtained in the above-described embodiments and modifications.

The arrows shown in FIGS. 6 and 11 are examples of flows of the signals and should not be construed as limiting the flow directions of the signals.

The flowcharts shown in FIGS. 10 and 12 should not be construed as limiting the respective procedures of the operations. It is also possible to make an addition or deletion to the procedures, or change the order of the procedures without departing from the spirit and scope of the present invention.

Otherwise, the above-described embodiments and modification embodiment may be combined in any manner deemed suitable.

Obviously, numerous modifications and variations of the present invention are possible in light of the above teachings. It is therefore to be understood that within the scope of the appended claims, the invention may be practiced otherwise than as specifically described herein.

What is claimed is:

1. An optical encoder comprising:
a to-be-detected medium comprising slits arranged at predetermined intervals to reflect and transmit light;
an optical source configured to radiate light to the to-be-detected medium;
a photodetector configured to detect the light radiated from the optical source and reflected by the slits or transmitted through the slits, and configured to generate an electrical signal corresponding to an amount of the light that has been detected;
a correction value storage storing an offset correction value used to eliminate or reduce an offset component contained in the electrical signal;
an adjustor configured to adjust at least one of an amount of the light radiated from the optical source and the offset correction value in accordance with at least one of the electrical signal and a moving velocity of the to-be-detected medium so that a ratio between the offset correction value and the amount of the light radiated from the optical source is approximately constant;
a signal corrector configured to correct, using the offset correction value, the electrical signal corresponding to the amount of the light that has been radiated from the optical source and that has been adjusted by the adjustor, or configured to correct the electrical signal using the offset correction value that has been adjusted by the adjustor, so as to eliminate or reduce the offset component; and
a position detector configured to detect a position of the to-be-detected medium using the electrical signal that has been corrected by the signal corrector.

2. The optical encoder according to claim 1,
wherein the adjustor is configured to adjust the offset correction value in accordance with the electrical signal so that the ratio between the offset correction value and the amount of the light that has been radiated from the optical source is approximately constant, and
wherein the signal corrector is configured to correct the electrical signal using the offset correction value that has been adjusted by the adjustor.

3. The optical encoder according to claim 2, further comprising:
an adjustment amount storage storing adjustment amount information indicating an amount of adjustment of the offset correction value relative to the amount of the light that has been radiated from the optical source;
an amplitude detector configured to detect an amplitude of the electrical signal; and
an optical source controller configured to, in accordance with the amplitude of the electrical signal detected by the amplitude detector, control the amount of the light radiated from the optical source so as to reduce a change in the amplitude of the electrical signal,
wherein the adjustor comprises a correction value decreasing section configured to decrease the offset correction value based on the amplitude and the adjustment amount information when the amplitude of the electrical signal reduces after the optical source controller has controlled the amount of the light that has been radiated from the optical source, and
wherein the signal corrector is configured to correct the electrical signal corresponding to the amount of the light that has been radiated from the optical source and that has been reduced using the offset correction value that has been decreased by the correction value decreasing section.

4. The optical encoder according to claim 2, further comprising:
a filter configured to eliminate or reduce a predetermined high-frequency component from the electrical signal;
a characteristic storage storing filtering characteristic information indicating an amplitude of the electrical signal that has been subjected to filtering by the filter and that is relative to the moving velocity of the to-be-detected medium;
an amplitude detector configured to detect the amplitude of the electrical signal that has been subjected to the filtering;
a velocity detector configured to detect the moving velocity of the to-be-detected medium; and
an optical source controller configured to, in accordance with the amplitude of the electrical signal detected by the amplitude detector, control the amount of the light radiated from the optical source so as to reduce a change in the amplitude of the electrical signal,
wherein the adjustor comprises a correction value increasing section configured to increase the offset correction value based on the moving velocity detected by the velocity detector and on the filtering characteristic information when the moving velocity of the to-be-detected medium increases and this increase causes the amplitude of the electrical signal detected by the amplitude detector to reduce, and when this reduction causes the optical source controller to increase the amount of the light that has been radiated from the optical source, and
wherein the signal corrector is configured to, using the offset correction value that has been increased by the correction value increasing section, correct the electrical signal corresponding to the amount of the light that has been radiated from the optical source and that has been increased by the optical source controller.

5. The optical encoder according to claim 1, further comprising a filter configured to eliminate or reduce a predetermined high-frequency component from the electrical signal,
wherein when the moving velocity of the to-be-detected medium increases, the adjustor is configured to adjust the amount of the light that has been radiated from the optical source or configured to adjust the offset correction value in accordance with the increase in the moving velocity of the to-be-detected medium so that the ratio between the offset correction value and the amount of the light that has been radiated from the optical source is approximately constant.

6. The optical encoder according to claim 5, further comprising:
a characteristic storage storing filtering characteristic information indicating an amplitude of the electrical signal that has been subjected to filtering by the filter and that is relative to the moving velocity of the to-be-detected medium;
an amplitude detector configured to detect the amplitude of the electrical signal that has been subjected to the filtering; and
a velocity detector configured to detect the moving velocity of the to-be-detected medium,
wherein the adjustor comprises an amplitude correction section configured to, when the moving velocity of the to-be-detected medium increases and this increase causes a reduction in the amplitude of the electrical signal that has been subjected to the filtering and that has been detected by the amplitude detector, compensate for the reduction in the amplitude of the electrical signal caused by the increase in the moving velocity of the to-be-detected medium, based on the moving velocity detected by the velocity detector and on the filtering characteristic information,
wherein the optical encoder further comprises an optical source controller configured to control the amount of the light that has been radiated from the optical source in accordance with the amplitude of the electrical signal that has been corrected by the amplitude correction section, so as to reduce a change in the amplitude of the electrical signal, and
wherein the signal corrector is configured to, using the offset correction value, correct the electrical signal corresponding to the amount of the light that has been radiated from the optical source and controlled by the optical source controller.

7. The optical encoder according to claim 5, further comprising:
an adjustment amount storage storing adjustment amount information indicating an amount of adjustment of the offset correction value relative to the amount of the light that has been radiated from the optical source,
an amplitude detector configured to detect an amplitude of the electrical signal that has been subjected to filtering by the filter, and
an optical source controller configured to, in accordance with the amplitude of the electrical signal detected by the amplitude detector, control the amount of the light that has been radiated from the optical source so as to reduce a change in the amplitude of the electrical signal,
wherein the adjustor comprises a correction value decreasing section configured to decrease the offset correction value based on the amplitude and the adjustment amount information when the amplitude of the electrical signal reduces after the optical source controller has controlled the amount of the light that has been radiated from the optical source, and
wherein the signal corrector is configured to correct the electrical signal corresponding to the amount of the light that has been radiated from the optical source and reduced using the offset correction value that has been decreased by the correction value decreasing section.

8. A motor apparatus comprising:
a motor configured to rotate a shaft; and
an optical encoder configured to detect a position of the shaft, the optical encoder comprising:
a to-be-detected medium coupled to the shaft and comprising slits arranged at predetermined intervals to reflect or transmit light;
an optical source configured to radiate light to the to-be-detected medium;
a photodetector configured to detect the light radiated from the optical source and reflected by the slits or transmitted through the slits, and configured to generate an electrical signal corresponding to an amount of the light that has been detected;
a correction value storage storing an offset correction value used to eliminate or reduce an offset component contained in the electrical signal;
an adjustor configured to adjust at least one of an amount of the light radiated from the optical source and the offset correction value in accordance with at least one of the electrical signal and a moving velocity of the to-be-detected medium so that a ratio between the offset correction value and the amount of the light radiated from the optical source is approximately constant;
a signal corrector configured to correct, using the offset correction value, the electrical signal corresponding to the amount of the light that has been radiated from the optical source and that has been adjusted by the adjustor, or configured to correct the electrical signal using the offset correction value that has been adjusted by the adjustor, so as to eliminate or reduce the offset component; and
a position detector configured to detect a position of the to-be-detected medium using the electrical signal that has been corrected by the signal corrector.

9. A method for processing a signal of an optical encoder,
the method being executed by an optical encoder comprising:
a to-be-detected medium comprising slits arranged at predetermined intervals to reflect or transmit light;
an optical source configured to radiate light to the to-be-detected medium;
a photodetector configured to detect the light radiated from the optical source and reflected by the slits or transmitted through the slits, and configured to generate an electrical signal corresponding to an amount of the light that has been detected; and
a correction value storage storing an offset correction value used to eliminate or reduce an offset component contained in the electrical signal,
the method comprising:
adjusting, by an adjustor, the amount of the light that has been radiated from the optical source or the offset correction value in accordance with at least one of a moving velocity of the to-be-detected medium and the electrical signal so that a ratio between an amount of the light radiated from the optical source and the offset correction value is approximately constant,
correcting, by a signal corrector using the offset correction value, the electrical signal corresponding to the amount of the emitted light that has been adjusted by the adjustor, or correcting, by the signal corrector, the electrical signal using the offset correction value that has been adjusted by the adjustor, so as to eliminate or reduce the offset component; and
detecting, by a position detector, a position of the to-be-detected medium using the electrical signal that has been corrected by the signal corrector.
